(19) United States
(12) Patent Application Publication
(10) Pub. No.: US 2026/0296636 A1
(43) Pub. Date: Oct. 1, 2026

(54) METHOD FOR MANAGING THE THRUST AND VELOCITY OF AN AIRCRAFT

(71) Applicant: AIRBUS OPERATIONS SAS, Toulouse (FR)

(72) Inventors: Xavier PRESSEQ, Toulouse (FR); Jean-Pierre DEMORTIER, Toulouse (FR); Manon BONDOUY, Toulouse (FR)

(73) Assignee: AIRBUS OPERATIONS SAS, Toulouse (FR)

(21) Appl. No.: 19/571,072

(22) Filed: Mar. 18, 2026

(30) Foreign Application Priority Data
Mar. 25, 2025 (FR) 2503038

(51) Int. Cl. B64C 13/18; G08G 5/21; G08G 5/23; G08G 5/52; G08G 5/76

(52) U.S. Cl. CPC B64C 13/18; G08G 5/21; G08G 5/23; G08G 5/52; G08G 5/76

(57) ABSTRACT

A method for managing the thrust and velocity of an aircraft, including, for at least one flight phase having a variation in altitude: receiving a thrust and velocity profile comprising, for each of a plurality of altitude slices, target thrust and velocity values; calculating, depending on the thrust and velocity profile and a current altitude of the aircraft, thrust and velocity setpoints; transmitting the thrust setpoint to an engine control system with a view to acting on an engine; and transmitting the velocity setpoint to a flight control system with a view to acting on flight control surfaces. The proposed solution makes it possible to improve management of the thrust and velocity of the aircraft and therefore to reduce degradation of the engine.

### TECHNICAL FIELD

The present invention relates to a method for managing the thrust and velocity of an aircraft in a flight phase of the aircraft comprising a variation in altitude (in particular the climbing phase, or a phase (scheduled during the cruising phase) of changing flight level).

The present invention also relates to a flight management system (FMS) located on board the aircraft and configured to implement such a method, as well as to a computer program product and storage medium allowing such a method to be implemented.

### PRIOR ART

The climbing phase of an aircraft (which follows the phase of taking off and precedes the cruising phase) generally involves selecting a max engine speed for climbing, called “max climb” engine speed, which is calibrated to obtain satisfactory climb-path characteristics, in particular in terms of acquisition of the climb altitude and of climb time, given the maximum weight of the aircraft.

When an aircraft of medium or low weight is operated at the “max climb” engine speed, the climb characteristics may greatly exceed those strictly necessary. In addition, since the “max climb” engine speed is high, and bearing in mind that the degradation of the engine (propulsion system) of the aircraft is dependent on thrust level, it causes degradation of the engine. In other words, each operation during which “max climb” engine speed is employed leads to use of the engine at a high speed, whatever the conditions on the day and whatever the weight of the aircraft, accentuating degradation of the engine. Given that engine degradation is accentuated by high thrust levels, using the “max climb” engine speed in every flight cycle means that this engine speed is a factor significantly impacting the degradation of the engine and therefore its service life.

Optionally, “fixed derate climb” speeds, with levels below the maximum level of the “max climb” speed, may be offered to the pilot. It is up to the pilot to manually select one of the derated speeds, depending on the weight conditions in question and on the airport and environmental constraints on the day.

The use of one of the “fixed derate climb” speeds allows a first level of reduction of engine degradation, but remains a sub-optimal solution because the pilot does not know which speed is best suited to the weight, airport and atmospheric conditions on any given day. In addition, local constraints on the day may lead to selection of a derated speed that changes throughout the climbing phase. One of the derated speeds is selected during the phase of preparing for the flight. Modification of the derate during the climbing phase requires the pilot to carry out manual operations, while being unaware of the optimum engine speed for the conditions on the day. The natural reaction of the pilot is to deselect the “fixed derate climb” speed during the climb to switch to the “max climb” speed.

Alternatively, advanced engine-control laws (called “auto derate climb” laws) taking into account the take-off weight of the aircraft on the day, have been developed to reduce thrust when the weight of the aircraft is less than maximum. These laws are predetermined for a given type of aircraft/engine. These advanced control laws are offered in addition to the “max climb” engine speed and are activatable and deactivatable by the pilot.

The use of advanced “auto derate climb” engine control laws does not guarantee compliance with the various constraints on any given day, potentially leading the pilot to select the “max climb” speed, thus missing out on the benefit to the service life of the engine.

The aforementioned known solutions (“max climb”, “fixed derate climb” speeds and “auto derate climb” advanced engine control laws) are satisfactory, but there is a need to improve them further.

### SUMMARY OF THE INVENTION

A method is proposed for managing the thrust and velocity of an aircraft, the method being implemented by a flight management system located on board the aircraft and comprising electronic circuitry, the method comprising, for at least one flight phase of the aircraft comprising a variation in altitude within a defined range of altitude values:
receiving a thrust and velocity profile comprising, for each altitude slice among a plurality of altitude slices of the defined range of altitude values, a target thrust value and a target velocity value;
calculating, depending on the thrust and velocity profile and on a current altitude of the aircraft, a thrust setpoint and a velocity setpoint;
transmitting the thrust setpoint to an engine control system located on board the aircraft and configured to act on an engine of the aircraft depending on the thrust setpoint; and
transmitting the velocity setpoint to a flight control system located on board the aircraft and configured to act on flight control surfaces of the aircraft depending on the velocity setpoint.

Thus, the proposed solution is based on provision of a thrust and velocity profile to the flight management system (FMS) of the aircraft, which uses it to automatically generate thrust and velocity setpoints. The proposed solution makes it possible to improve management of the thrust and velocity of an aircraft during the climbing phase (or any other flight phase of the aircraft comprising a variation in altitude), while respecting various constraints related to this climbing phase and while simplifying the pilot's role in this management. This improvement in the management of the thrust and velocity of the aircraft allows engine degradation (wear) to be reduced, by reducing internal operating temperatures. This reduction in engine wear itself allows engine maintenance cycles and the associated costs to be reduced, and therefore improves the availability of aircraft to operators.

According to one particular embodiment, said at least one flight phase, comprising a variation in altitude, belongs to a group containing:
a phase of climbing to cruising altitude; and
a phase of changing flight level, scheduled during a cruising phase.

According to one particular embodiment, calculating the thrust setpoint and velocity setpoint comprises:
calculating a predicted climb path, of the aircraft, depending on the thrust and velocity profile and on performance characteristics of the aircraft; and
calculating the thrust setpoint and velocity setpoint depending on the predicted climb path.

According to one particular embodiment, the method comprises: calculating a predicted fuel consumption, of the aircraft, depending on the thrust and velocity profile and on performance characteristics of the aircraft.

According to one particular embodiment, the thrust and velocity profile depends on at least one parameter belonging to a group containing:
a parameter regarding fuel consumption by the aircraft;
a parameter regarding a level of acoustic emission by the aircraft;
a parameter regarding a level of pollutant emission by the aircraft;
a parameter regarding a cost of engine maintenance to the aircraft;
a parameter regarding a constraint related to air traffic control in respect of reaching a cruising phase following a climbing phase;
a parameter regarding an airport constraint in respect of the climbing phase;
a parameter regarding an environmental constraint related to particles present in the atmosphere;
a meteorological parameter; and
a parameter related to a performance characteristic of the aircraft.

According to one particular embodiment, the thrust and velocity profile is received via an interface included in the flight management system and belonging to a group containing:
a human-machine interface for entry of the thrust and velocity profile by the pilot or another person present in the aircraft;
an interface for receiving the thrust and velocity profile transmitted by a device located on board the aircraft, in particular a tablet; and
an interface for receiving the thrust and velocity profile transmitted by a device on the ground.

According to one particular embodiment, for each altitude slice, the target thrust value is selected from a plurality of thrust values of a set belonging to a group containing:
a first set of thrust values each corresponding to one distinct engine speed among a plurality of engine speeds available in the engine control system; and
a second set of thrust values each corresponding to a particular percentage of a maximum thrust value of a given engine speed available in the engine control system.

According to one particular embodiment, the method comprises: displaying at least one piece of information belonging to a group containing:
the thrust and velocity profile;
the thrust setpoint and velocity setpoint, calculated depending on the thrust and velocity profile;
a predicted climb path, calculated depending on the thrust and velocity profile; and
a predicted fuel consumption, calculated depending on the thrust and velocity profile.

A computer program product comprising instructions that cause a processor to execute any of the embodiments of the aforementioned method, when said instructions are executed by the processor, is also proposed.

A storage medium, storing such instructions that cause a processor to execute any of the embodiments of the aforementioned method, when said instructions are read from the storage medium and executed by the processor, is also proposed.

A flight management system is also proposed, said flight management system being located on board an aircraft and comprising electronic circuitry configured to implement, for at least one flight phase of the aircraft comprising a variation in altitude within a defined range of altitude values:
reception of a thrust and velocity profile comprising, for each altitude slice among a plurality of altitude slices of the defined range of altitude values, a target thrust value and a target velocity value;
calculation, depending on the thrust and velocity profile and on a current altitude of the aircraft, of a thrust setpoint and a velocity setpoint;
transmission of the thrust setpoint to an engine control system located on board the aircraft and configured to act on an engine of the aircraft depending on the thrust setpoint; and
transmission of the velocity setpoint to a flight control system located on board the aircraft and configured to act on the flight control surfaces of the aircraft depending on the velocity setpoint.

An aircraft comprising a flight management system as described above, and more generally configured to execute any of the embodiments of the method described above (method for managing the thrust and velocity of an aircraft), is also proposed.

### BRIEF DESCRIPTION OF THE DRAWINGS

The aforementioned features of the invention, along with others, will become more clearly apparent on reading the following description of at least one example of embodiment, said description being given with reference to the appended drawings, in which:

FIG. 1 schematically illustrates a side view of an aircraft equipped with a flight management system (FMS) according to the invention, configured to manage the thrust and velocity of the aircraft during a climbing phase;

FIG. 2 schematically illustrates one embodiment of the flight management system of FIG. 1;

FIG. 3 schematically illustrates one example of a software architecture of one embodiment of the flight management system of FIG. 1;

FIG. 4 schematically illustrates one example of a hardware architecture of one embodiment of the flight management system of FIG. 1;

FIG. 5 schematically illustrates one example of an algorithm, executed by the flight management system of FIG. 1, for managing the thrust and velocity of the aircraft during a climbing phase; and

FIG. 6 schematically illustrates one example of a thrust and velocity profile according to one embodiment.

### DETAILED DESCRIPTION OF EMBODIMENTS

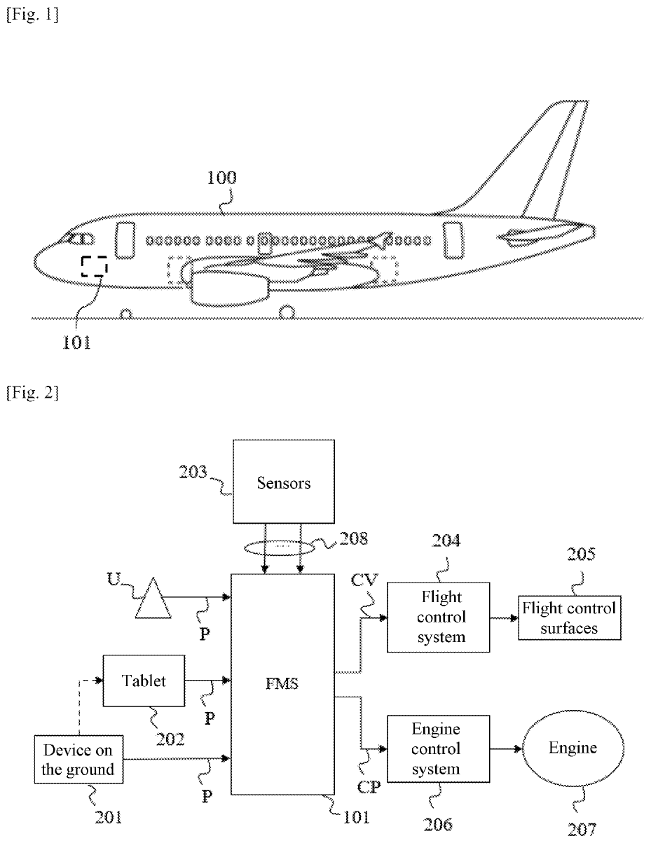

FIG. 1 schematically illustrates a side view of an aircraft 100 equipped with a flight management system (FMS) 101 according to the invention, i.e. configured to manage the thrust and velocity of the aircraft during the climbing phase (or any other flight phase of the aircraft comprising a variation in altitude).

In the embodiment illustrated in FIG. 2, the flight management system (FMS) 101 receives a thrust and velocity profile P. For the sake of simplification, the following three embodiments are illustrated in FIG. 2:
in a first embodiment, the thrust and velocity profile P is provided by the pilot U (who was for example provided with it in a flight brief) via a human-machine entry interface (manual entry for example). For example, in a phase of preparing for the flight, the aircraft being stationary on the ground, the pilot enters the thrust and velocity profile into the flight management system (FMS) via a dedicated interface allowing each and every adjustment parameter of the climbing phase to be input;
in a second embodiment, the thrust and velocity profile P is provided by a device located on board the aircraft, a tablet 202 for example; and
in a third embodiment, the thrust and velocity profile P is provided by a device 201 on the ground, either directly or via the tablet 202.

The flight management system 101 receives measurements of various parameters 208 representative of the state of the aircraft (for example: velocity, altitude, air temperature, etc.), delivered by sensors 203 with which the aircraft is equipped.

As detailed below, depending on the thrust and velocity profile P and on the various state parameters 208 (in particular the current altitude of the aircraft), the flight management system 101 calculates a thrust setpoint CP and a velocity setpoint CV. The thrust setpoint CP for example comprises values of one or more engine control parameters: rotation speed, power level, engine setpoint temperature, thrust derate with respect to the maximum available thrust, etc.

The flight management system 101 transmits the thrust setpoint CP to an engine control system 206 located on board the aircraft 100 and configured to act on an engine 207 of the aircraft depending on the thrust setpoint CP. The engine control system 206 adjusts the fuel flow level or the power level in order to obtain the requested engine thrust.

The flight management system 101 transmits the velocity setpoint CV to a flight control system 204 also located on board the aircraft and configured to act on flight control surfaces 205 of the aircraft 100 depending on the velocity setpoint CV. The flight control system 204 calculates steering commands for each of the aerodynamic flight control surfaces so as to keep the aircraft at the received velocity setpoint.

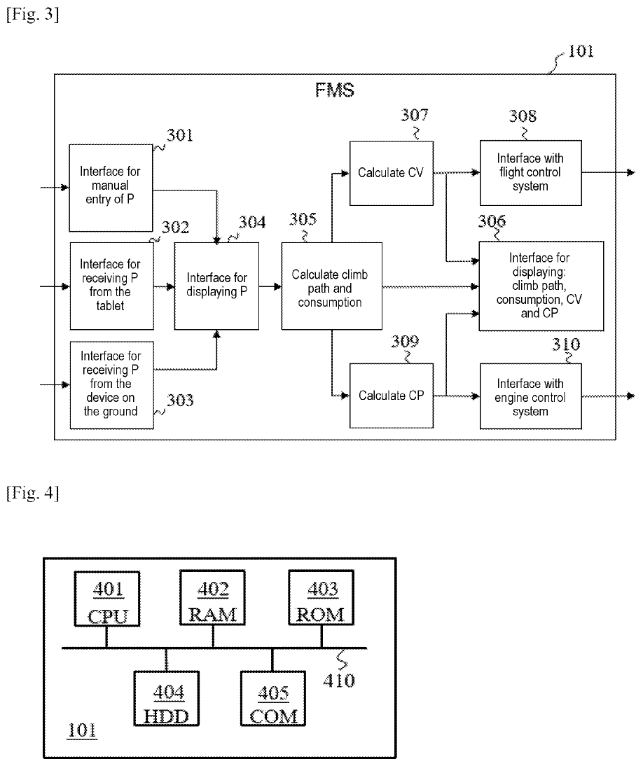

FIG. 3 schematically illustrates one example of a software architecture of the flight management system (FMS) 101, which then comprises:
to receive the thrust and velocity profile P, one or more of the following three interface modules:
   a human-machine interface module 301 for entry of the thrust and velocity profile P by the pilot U (or another person present in the aircraft);
   an interface module 302 for receiving the thrust and velocity profile P transmitted by the tablet 202 (or another device located on board the aircraft); and
   an interface module 303 for receiving the thrust and velocity profile P transmitted (directly) by the device 201 on the ground;
an interface module 304 for displaying the thrust and velocity profile P;
a module 305 for calculating a predicted climb path and a predicted fuel consumption, of the aircraft, depending on the thrust and velocity profile P and on performance characteristics of the aircraft 100;
a module 307 for calculating the velocity setpoint CV depending on the predicted climb path;
a module 308 for interfacing with the flight control system 204, with a view to supplying it with the velocity setpoint (see description of FIG. 2);
a module 309 for calculating the thrust setpoint CP depending on the predicted climb path;
a module 310 for interfacing with the engine control system 206, with a view to supplying it with the thrust setpoint (see description of FIG. 2); and
an interface module 306 for displaying the predicted climb path, the predicted fuel consumption, the velocity setpoint CV and the thrust setpoint CP.

FIG. 4 schematically illustrates one example of the hardware architecture of the flight management system (FMS) 101, which then comprises the following, connected by a communication bus 410: a processor or CPU (central processing unit) 401; a random-access memory (RAM) 402; a read-only memory (ROM) 403, for example a flash memory; a data storage device, such as a hard disk drive (HDD), or a storage medium reader, such as a Secure Digital (SD) card reader 404; and at least one communication interface 405 allowing the flight management system 101 to interact with the avionics of the aircraft 100.

The processor 401 is capable of executing instructions that form a computer program and that are loaded into the RAM 402 from the ROM 403, from an external memory (not shown), from another storage medium (such as an SD card), or from a communication network (not shown). When the flight management system 101 is turned on, the processor 401 is capable of reading the aforementioned instructions from the RAM 402 and of executing them. When they are read (from the RAM 402 or a storage medium) and executed by the processor 401, these instructions (which form a computer program) cause the processor 401 to execute the behaviours, steps and algorithm described here.

All or some of the behaviours, steps and algorithm described here may thus be implemented in software form by executing a set of instructions using a programmable machine, such as a digital signal processor (DSP) or a microcontroller, or be implemented in hardware form by a machine or a dedicated component (chip) or a dedicated set of components (chipset), such as a field-programmable gate array (FPGA) or an application-specific integrated circuit (ASIC). Generally, the flight management system 101 comprises electronic circuitry arranged and configured to implement the behaviours, steps and algorithms described here.

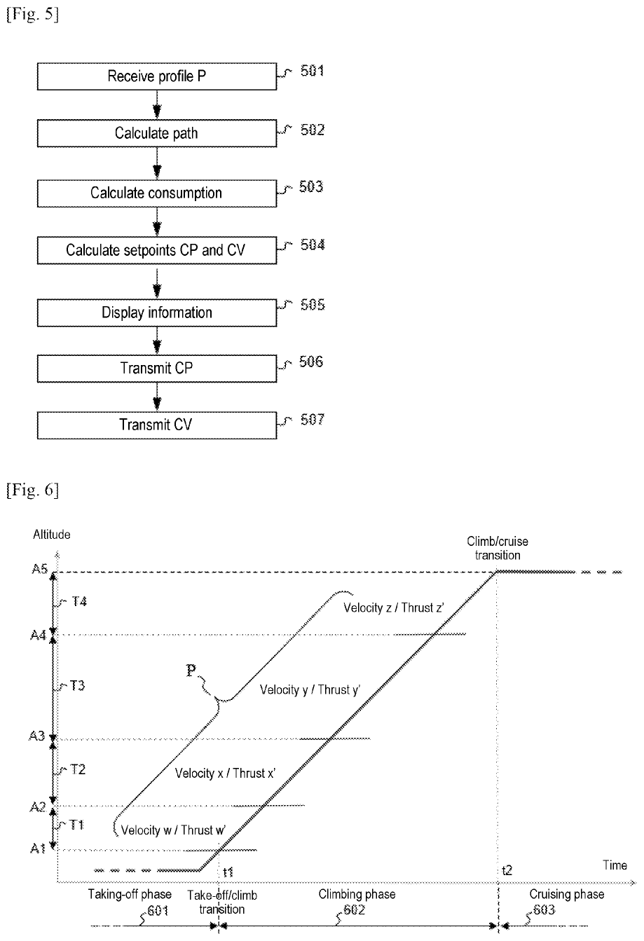

FIG. 5 schematically illustrates one example of an algorithm for managing the thrust and velocity of the aircraft during a climbing phase. This algorithm is executed by the flight management system (FMS) 101, for one or more flight phases of the aircraft comprising a variation in altitude within a defined range of altitude values. For example, it is executed for the phase of climbing to a cruising altitude (see the example of FIG. 6), and for each phase (scheduled during the cruising phase) of changing flight level (changes of “step climb” type).

In a step 501, the flight management system 101 receives, via one of its interfaces 301 to 303, see FIG. 3), a thrust and velocity profile P comprising, for each altitude slice among a plurality of altitude slices of the defined range of altitude values (for example for the climbing phase), a target thrust value and a target velocity value. In a given altitude slice, the target thrust and velocity values are considered constant.

FIG. 6 schematically illustrates one example of a thrust and velocity profile P according to one embodiment. Altitude is represented on the y-axis and time on the x-axis. The climbing phase 602 takes place between the times t1 (time of transition between the taking-off phase 601 and the climbing phase 602) and t2 (time of transition between the climbing phase 602 and the cruising phase 603). For the climbing phase 602, the thrust and velocity profile P comprises:
for altitude slice T1 (from altitude A1 to altitude A2), the target velocity value w and the target thrust value w′;
for altitude slice T2 (from altitude A2 to altitude A3), the target velocity value x and the target thrust value x′;
for altitude slice T3 (from altitude A3 to altitude A4), the target velocity value y and the target thrust value y′; and
for altitude slice T4 (from altitude A4 to altitude A5), the target velocity value z and the target thrust value z′.

In other examples, the number of altitude slices may be different.

In one embodiment, for each altitude slice, the target thrust value is selected from a set of thrust values each corresponding to one distinct engine speed among a plurality of engine speeds available in the engine control system 206. In another embodiment, for each altitude slice, the target thrust value is selected from a set of thrust values each corresponding to one particular percentage of a maximum thrust value of a given engine speed available in the engine control system 206.

The thrust and velocity profile P may be optimized (for example in the tablet 202 or in the device 201 on the ground), by determining the target thrust and velocity values of each altitude slice depending on one or more parameters, for example among:
criteria determined by the airline:
   a parameter regarding fuel consumption by the aircraft;
   a parameter regarding a level of acoustic emission by the aircraft;
   a parameter regarding a level of pollutant (for example CO2, NOx, etc.) emission by the aircraft;
   a parameter regarding a cost of engine maintenance to the aircraft;
constraints:
   a parameter regarding a constraint related to air traffic control in respect of reaching the cruising phase;
   a parameter regarding an airport constraint in respect of the climbing phase (minimum slope, minimum altitude and/or velocity at geographical points, etc.);
   a parameter regarding an environmental constraint related to particles present in the atmosphere (sand, salt, chemical pollutants, etc.);
   a meteorological parameter (temperature, wind, etc.); and
performance characteristics of the aircraft (based on an “aircraft performance” model).

Returning to the description of FIG. 5, in a step 502, the flight management system 101 calculates a predicted climb path of the aircraft, depending on the thrust and velocity profile P and on performance characteristics of the aircraft 100.

In a step 503, the flight management system 101 calculates a predicted fuel consumption of the aircraft, depending on the thrust and velocity profile P and on performance characteristics of the aircraft 100.

In a step 504, the flight management system 101 calculates the velocity setpoint CV and thrust setpoint CP depending on the predicted climb path.

In a step 505, the flight management system 101 displays various pieces of information, for example: the thrust and velocity profile P, the predicted climb path, the predicted fuel consumption, the velocity setpoint CV and the thrust setpoint CP.

In a step 506, the flight management system 101 transmits the thrust setpoint CP to the flight control system 204, so that the latter may act on the flight control surfaces 205 of the aircraft 100 depending on this thrust setpoint CP.

In a step 507, the flight management system 101 transmits the velocity setpoint to the engine control system 206, so that the latter may act on the engine 207 of the aircraft depending on this velocity setpoint CV.

1. A method for managing the thrust and velocity of an aircraft, the method being implemented by a flight management system located on board the aircraft and comprising electronic circuitry, the method comprising, for at least one flight phase of the aircraft comprising a variation in altitude within a defined range of altitude values:
receiving a thrust and velocity profile comprising, for each altitude slice among a plurality of altitude slices of the defined range of altitude values, a target thrust value and a target velocity value;
calculating, depending on the thrust and velocity profile and on a current altitude of the aircraft, a thrust setpoint and a velocity setpoint;
transmitting the thrust setpoint to an engine control system (206) located on board the aircraft and configured to act on an engine (207) of the aircraft depending on the thrust setpoint; and
transmitting the velocity setpoint to a flight control system located on board the aircraft and configured to act on flight control surfaces of the aircraft depending on the velocity setpoint.

2. The method according to claim 1, wherein said at least one flight phase, comprising a variation in altitude, is:
a phase of climbing to a cruising altitude; or
a phase of changing flight level, scheduled during a cruising phase.

3. The method according to claim 1, wherein calculating the thrust setpoint and velocity setpoint comprises:
calculating a predicted climb path, of the aircraft, depending on the thrust and velocity profile and on performance characteristics of the aircraft; and
calculating (504) the thrust setpoint and velocity setpoint depending on the predicted climb path.

4. The method according to claim 1, comprising: calculating a predicted fuel consumption, of the aircraft, depending on the thrust and velocity profile and on performance characteristics of the aircraft.

5. The method according to claim 1, wherein the thrust and velocity profile depends on at least one parameter belonging to a group containing:
a parameter regarding fuel consumption by the aircraft;
a parameter regarding a level of acoustic emission by the aircraft;
a parameter regarding a level of pollutant emission by the aircraft;
a parameter regarding a cost of engine maintenance to the aircraft;
a parameter regarding a constraint related to air traffic control in respect of reaching a cruising phase following a climbing phase;
a parameter regarding an airport constraint in respect of the climbing phase;
a parameter regarding an environmental constraint related to particles present in the atmosphere;
a meteorological parameter; and
a parameter related to a performance characteristic of the aircraft.

6. The method according to claim 1, wherein the thrust and velocity profile is received via an interface included in the flight management system and belonging to a group containing:
a human-machine interface for entry of the thrust and velocity profile by the pilot or another person present in the aircraft;
an interface for receiving the thrust and velocity profile transmitted by a device located on board the aircraft, in particular a tablet; and
an interface for receiving the thrust and velocity profile transmitted by a device on the ground.

7. The method according to claim 1, wherein, for each altitude slice, the target thrust value is selected from a plurality of thrust values of a set belonging to a group containing:
a first set of thrust values each corresponding to one distinct engine speed among a plurality of engine speeds available in the engine control system; and
a second set of thrust values each corresponding to a particular percentage of a maximum thrust value of a given engine speed available in the engine control system.

8. The method according to claim 1, comprising:
displaying at least one piece of information belonging to a group containing:
the thrust and velocity profile;
the thrust setpoint and velocity setpoint, calculated depending on the thrust and velocity profile;
a predicted climb path, calculated depending on the thrust and velocity profile; and
a predicted fuel consumption, calculated depending on the thrust and velocity profile.

9. (canceled)

10. A non-transitory storage medium storing a computer program comprising instructions that cause a processor to execute the method according to claim 1, when said instructions are read from the storage medium and executed by the processor.

11. A flight management system, located on board an aircraft and comprising electronic circuitry configured to implement, for at least one flight phase of the aircraft comprising a variation in altitude within a defined range of altitude values,
reception of a thrust and velocity profile comprising, for each altitude slice among a plurality of altitude slices of the defined range of altitude values, a target thrust value and a target velocity value;
calculation, depending on the thrust and velocity profile and on a current altitude of the aircraft, of a thrust setpoint and a velocity setpoint;
transmission of the thrust setpoint to an engine control system located on board the aircraft and configured to act on an engine of the aircraft depending on the thrust setpoint; and
transmission of the velocity setpoint to a flight control system located on board the aircraft and configured to act on flight control surfaces of the aircraft depending on the velocity setpoint.

12. An aircraft comprising the flight management system according to claim 11.
